(19) United States
(12) Patent Application Publication
(10) Pub. No.: US 2022/0358339 A1
(43) Pub. Date: Nov. 10, 2022

(54) RFID DEVICES WITH CONTROLLED OPTICAL PROPERTIES

(71) Applicant: Avery Dennison Retail Information Services LLC, Mentor, OH (US)

(72) Inventors: Ian J. FORSTER, Chelmsford (GB); Elizabeth SOWLE, Bellbrook, OH (US); Brad CUMBY, Liberty Township, OH (US); Carol CALLAHAN, Greensboro, NC (US)

(21) Appl. No.: 17/631,246

(22) PCT Filed: Jul. 31, 2020
(86) PCT No.: PCT/US2020/044433

§ 371 Date: Jan. 28, 2022

Related U.S. Application Data
(60) Provisional application No. 62/880,804, filed on Jul. 31, 2019.

(51) Int. Cl. G06K 19/077

(52) U.S. Cl. CPC G06K 19/07716; G06K 19/07752; G06K 19/07783; G06K 19/07705

(57) ABSTRACT

An RFID device includes an antenna that is formed so as to control the optical properties of the RFID device, which may include minimizing the amount of light that will be transmitted through the RFID device or allowing for the passage of a predetermined amount of light therethrough. The RFID device includes a conductive material associated with a substrate. The conductive material includes an antenna and a periphery. An RFID chip is electrically coupled to the antenna, but not to the periphery. The antenna may be defined by a cutting or etching or printing process. A gap between the antenna and the periphery may be on the order of approximately 25 μm-200 μm (if the transmission of light through the RFID device is to be minimized) or greater in at least one section (if the passage of a predetermined amount of light through the RFID device would be desirable).

### CROSS REFERENCE TO RELATED APPLICATION

The present application claims the benefit of U.S. Provisional Patent Application No. 62/880,804 filed Jul. 31, 2019, which is incorporated herein by reference in its entirety.

### FIELD OF THE DISCLOSURE

The present subject matter relates to radio frequency identification (“RFID”) devices. More particularly, the present subject matter relates to approaches to forming the antenna of an RFID device so as to control the optical properties of the RFID device.

### DESCRIPTION OF RELATED ART

Devices incorporating RFID technology are widely used for a variety of applications, including vehicle security locks, access control to buildings, and inventory tracking systems in manufacturing, warehouses, in-store retail, and other operations enhanced by tracking functions.

RFID devices may have a variety of integrated components, among them an RFID chip containing data (e.g., an identification code) and an antenna electrically connected to the chip and responsible for transmitting signals to and/or receiving signals from another RFID device (e.g., an RFID reader system).

Commonly, the antenna is manufactured by patterning, etching, or printing a conductor on a substrate in a pattern that corresponds to the desired shape of the antenna. The tracks or conductive lines thereby composing the antenna will normally contain or include opaque conductive materials (such as silver, copper or aluminum), which do not allow light transmission. The substrate associated with the antenna is typically a thin, flexible material, which may be transparent or at least translucent or otherwise configured to allow for the passage of light therethrough. This sharp contrast between the opaque antenna and the light-transmissive substrate can interfere with the appearance of materials (such as fabric labels) placed in front of conventional RFID devices. This may be especially disadvantageous for articles for which the appearance of the article is critical to marketability. For example, the aesthetic appeal of articles such as apparel labels/tags having RFID inlays may be affected due to visibility of parts of the RFID inlays through the label/tag substrate. Ideally, in these applications, no RFID device structures (e.g., conductive lines crossing a label) should be visible.

One possible approach to this problem is the use of thicker, highly opaque fabric or paper as a substrate. Thicker materials, however, can be rigid resulting in discomfort to wearer of these garments. Therefore, it is desirable for the RFID device to be soft and flexible. in which case the use of thicker substrate material is not satisfactory. Moreover, while it is desirable that the parts of the RFID device such as the antenna be invisible, it is at the same time also desirable that the logo or branding of the article to which the RFID device is tagged or attached to, be visibly and aesthetically enhanced.

### SUMMARY

There are several aspects of the present subject matter which may be embodied separately or together in the devices and systems described and claimed below. These aspects may be employed alone or in combination with other aspects of the subject matter described herein, and the description of these aspects together is not intended to preclude the use of these aspects separately or the claiming of such aspects separately or in different combinations as set forth in the claims appended hereto.

Methods for manufacturing an RFID device with controlled optical properties are described herein. The method includes providing a conductive material on a substrate and processing the conductive material to separate an antenna from a periphery, with the periphery being retained on the substrate. The antenna is separated from the periphery through a gap, with at least a portion of the gap being formed along a perimeter of one or more branding symbols, such as a logo or other brand identifying mark, design, etc., formed on a substrate of the RFID device. In some embodiments, the RFID chip is electrically coupled to the antenna, but not to the periphery.

In some embodiments, the method is as described above, and the conductive material is processed, for example, by cutting (e.g., die cutting), laser cutting, and/or etching in order to separate an antenna from a periphery, with the periphery being retained on the substrate. In some embodiments, the method is as described above and the conductive material, e.g., the antenna, has first and second portions, which are separated from a periphery, with the periphery being retained on the substrate. In some embodiments, the method is as described above, and the RFID chip is associated with a strap substrate at least partially formed of an opaque material and configured to extend between the first and second portions of the antenna.

In some embodiments, the method is as described above and at least a portion of the gap has a width configured to allow for the passage of a predetermined amount of light therethrough, the configuration being able to depict desired shapes, logos, designs, marks, or other optical characteristics. In still other embodiments, at least a portion of the gap is formed along a perimeter of one or more branding symbols (e.g., logo or other brand identifying mark, design, etc.) formed on the substrate of the RFID device.

In still other embodiments, at least a portion of the gap is formed along a perimeter of the one or more branding symbols formed/printed in the substrate of the RFID device. In some embodiments, the method is as described as above and further includes printing a conductive material onto a substrate so as to define an antenna and a periphery. In some embodiments, an RFID chip is electrically coupled to the antenna, but not to the periphery. The printing includes creating a gap between the antenna and the periphery, with at least a portion of the gap having a width configured to allow for the passage of a predetermined amount of light therethrough, the configuration being able to depict or enhance desired shapes, logos, design, marks, or other optical characteristics.

In some embodiments, the method is as described above and further includes providing a conductive material and defining a gap in the conductive material to configure it as a substantially spiral-shaped antenna, with at least a portion of the gap being formed along a perimeter of one or more branding symbols formed on the substrate of the RFID device. RFID device includes a substrate, a conductive material associated with the substrate, and an RFID chip are also described herein. In some embodiments, the conductive material contains an antenna and a periphery, with the RFID chip being electrically coupled to the antenna, but not to the periphery.

In some embodiments, the RFID device is as described above and further include controlled optical properties. In some embodiments, the conductive material includes an antenna and a periphery separated by a gap, with the RFID chip being electrically coupled to the antenna, but not to the periphery, and with the gap having a width in the range of approximately 25 μm to 200 μm.

In some embodiments, the RFID device is as described above and the antenna has first and second portions, with the RFID chip being associated with a strap substrate at least partially formed of an opaque material and extending between the first and second portions of the antenna.

### BRIEF DESCRIPTION OF THE DRAWINGS

FIG. 1 is a top plan view of an RFID device according to an aspect of the present disclosure;

FIG. 2 is a top plan view of a substrate and conductive material of an RFID device according to another aspect of the present disclosure;

FIG. 3 is a top plan view of the substrate and conductive material of FIG. 2, with an RFID strap secured thereto;

FIG. 4 is a top plan view of another embodiment of an RFID device according to an aspect of the present disclosure;

FIG. 5 is a top plan view of a substrate and conductive material of an RFID device;

FIG. 6 is a top plan view of the substrate and conductive material of FIG. 5, with a masking member or material provided to reduce the visibility of the substrate through a gap defined in the conductive material; and

FIG. 7 is a cross-sectional view of an RFID device according to an aspect of the present disclosure, with a masking member or material received by a gap defined in a conductive material of the RFID device.

### DESCRIPTION OF THE ILLUSTRATED EMBODIMENTS

The embodiments disclosed herein are for the purpose of providing a description of the present subject matter, and it is understood that the subject matter may be embodied in various other forms and combinations not shown in detail. Therefore, specific designs and features disclosed herein are not to be interpreted as limiting the subject matter as defined in the accompanying claims.

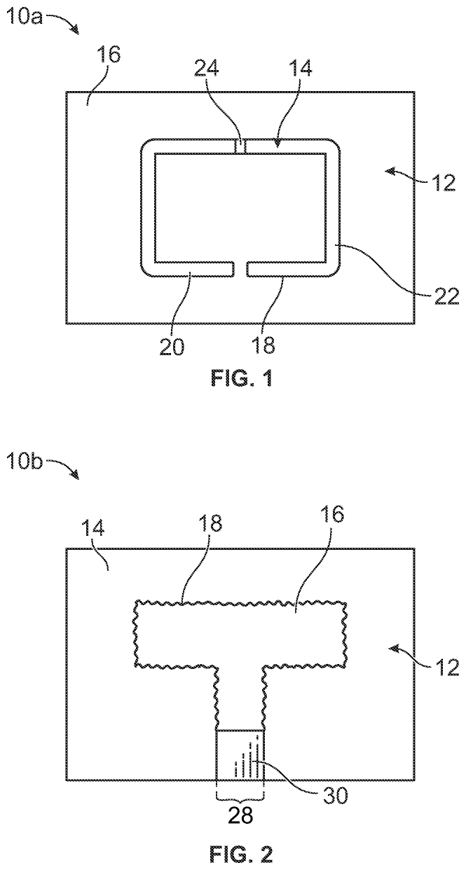

FIG. 1 shows one embodiment of an RFID device (shown generally as 10a) in accordance with an aspect of the present disclosure. In the illustrated embodiment, a conductive material 12 is provided on or associated with a substrate (which is not visible in FIG. 1). The conductive material 12 may be associated with the substrate according to any suitable approach, including (but not limited to) printing the conductive material 12 onto the substrate. The conductive material 12 may include or contain any suitable conductor, such as silver, copper, or aluminum. As for the substrate, it may be contain, include, or be composed of any suitable (preferably non-conductive) material without departing from the scope of the present disclosure.

The conductive material 12 may cover any portion of the substrate, but in one embodiment, is applied to an entire surface of the substrate. The portion of the substrate onto which the conductive material 12 is applied will have substantially uniform optical properties (i.e., that portion of the RFID device 10a will be substantially opaque, due to the presence of the conductive material 12). By applying the conductive material 12 to an entire surface of the substrate, the resulting RFID device 10a will have controlled, more uniform optical properties, as will be described in greater detail. Due to the conductive material 12 being applied in a manner that provides the RFID device 10a with more uniform optical properties, more flexibility is possible with the material composition of the conductive material 12 and the substrate, as described above. For example, the opacity of the substrate is not a consideration when the conductive material 12 is applied in a manner that is entirely controlling of the optical properties of the resulting RFID device 10a.

As also shown in FIG. 1, the conductive material 12 is processed to define an antenna 14 and a periphery 16, which is electrically isolated from the antenna 14 without being removed from the substrate. In other words, the antenna 14 is formed within the conductive material 12 without breaking the edges of the antenna 14 from the peripheral conductive material. In one embodiment, the antenna 14 and the periphery 16 are physically separated by one or more gaps 18 defined in the conductive material 12, which also serves to electrically isolate the antenna 14 from the remainder of the conductive material 12 (i.e., the periphery 16). It may be advantageous for the gap(s) 18 to pass entirely through the conductive material 12 without extending into the substrate (which could weaken the substrate), though it is also within the scope of the present disclosure for at least a portion of a gap 18 to extend into the underlying substrate. The gap(s) 18 could be created after the conductive material 12 has been applied to the substrate, such as by an etching or cutting (e.g., laser cutting or die cutting) operation. Further, in one embodiment, the gap(s) 18 could be continuously formed. In particular, the gap(s) 18 are formed along a perimeter of one or more branding symbols including logos or patterns formed on the substrate. In another embodiment, the conductive material 12 is printed onto the substrate in the form of the antenna 14 and periphery 16, with the gap(s) 18 being formed in regions where the conductive material 12 is not printed.

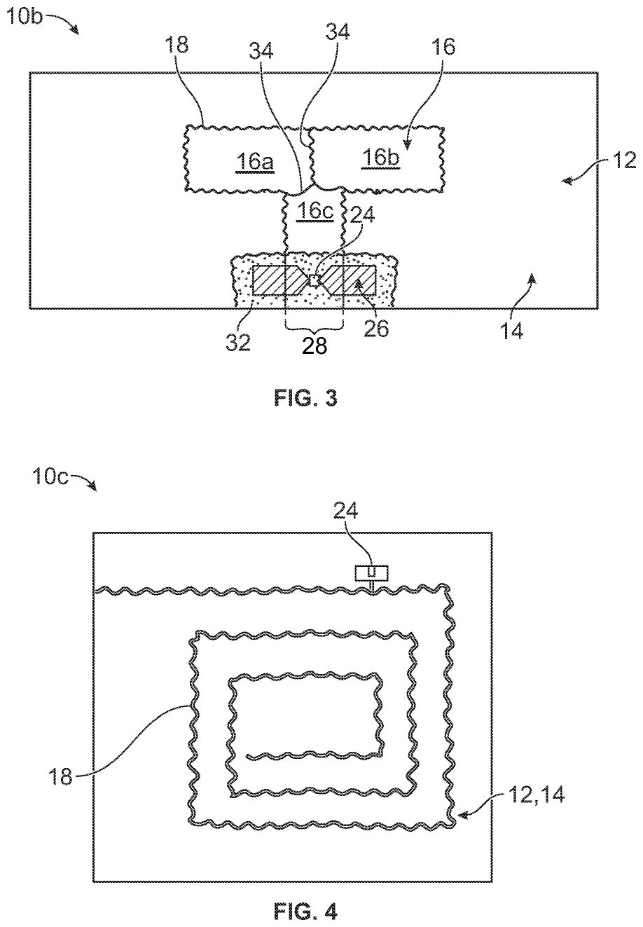

Regardless of how the antenna 14 and periphery 16 are defined, they may be provided in any suitable configuration without departing from the scope of the present disclosure. For example, in the embodiment of FIG. 1, the antenna 14 is completely surrounded by the periphery 16 and includes separate first and second portions 20 and 22. In the embodiment of FIGS. 2 and 3, the antenna 14 substantially encircles the periphery 16. It should be understood that the configurations of the antenna 14 and the periphery 16 shown in FIGS. 1-3 are merely exemplary and that other configurations may be practiced without departing from the scope of the present disclosure (e.g., an embodiment in which the antenna 14 substantially encircles one portion of the periphery 16, while another portion of the periphery 16 completely surrounds the antenna 14).

In one embodiment, each gap 18 is narrow or has a small width, which may be in the range of approximately 25 μm to 200 μm. By providing a narrow gap or gaps 18, no appreciable amount of light will be transmitted through the gap(s) 18. This serves to maintain the uniformity of the optical properties of RFID device 10a, with the antenna 14 and periphery 16 (which is retained on the substrate) being opaque and with the gap(s) 18 therebetween being substantially non-transmissive of light, thus rendering the entire RFID device 10a (or at least the portion thereof in which the conductive material 12 is present) substantially, uniformly opaque. Another advantage of a gap or gaps 18 having a small width is that such a configuration allows for the conductive material 12 to present a substantially flat surface. A conventional RFID device will include larger spaces (e.g., on the order of approximately 10 mm) defined between portions of the antenna, which presents an uneven surface that may be difficult to print upon without significant distortion. Thus, by employing a narrow gap or gaps 18 to separate the antenna 14 from the periphery 16, the clarity of print applied to the RFID device 10a will be improved.

While it may be advantageous in many applications for the gap(s) 18 to be relatively narrow, it is within the scope of the present disclosure for all or a portion of a gap 18 to be wide enough to allow for an appreciable or predetermined amount of light to be transmitted therethrough. As described above, the gap(s) 18 may be provided in any configuration without departing from the scope of the present disclosure. As such, it may be desirable to provide a gap or gaps 18 (or one or more portions thereof) with a greater width and a configuration in the form of a logo or other desired pattern. In such an embodiment, an appreciable or predetermined amount of light will pass through the gap(s) 18 to display the logo or pattern, thereby acting as a visual enhancement for the RHD device 10a and an associated label or the like. For example, the gap(s) 18 are formed to be positioned along a perimeter of one or more branding symbols formed in the substrate. Forming gap(s) 18 along the perimeter of the one or more branding symbols including a logo or a pattern ensures that there is passage or transmission of sufficient light to enhance the visibility of the branding symbols, while ensuring that there is no or minimal light transmission through the antenna 14. Thus, the construction of the RFID device 10a enables achieving controlled optical properties. Therefore, the construction of the RHD device 10a ensures that there is no visual interference of parts of the RFID device such as the antenna 14 with the branding of the article to which the RFID device 10a is secured. Additionally, the design degrees of freedom associated with the RFID device 10a are also high since the gap(s) 18 can be customized to be formed according to the shape and size of the branding symbols and according to their relative positioning on the substrate. Alternatively, the gap(s) 18 can be formed along a portion of the substrate that carries additional information such as wash care or anti counterfeit details.

Regardless of the particular configuration of the antenna 14, it is electrically coupled to an RFID chip 24. On account of the antenna 14 being electrically isolated from the periphery 16, the periphery 16 is not electrically coupled to the RFID chip 24. The RFID chip 24 may be electrically coupled to the antenna 14 according to any suitable approach, which may include direct attachment of the RFID chip 24 to the antenna 14 (as in FIG. 1) or attachment of an RFID strap 26 to the antenna 14 (as in FIG. 3). Although the periphery 16 of the conductive material is electrically isolated from the antenna, the periphery is still a part of the antenna and contributes to the functioning of the antenna 14.

When an RFID strap 26 is employed, a larger gap between two portions of the antenna 14 is required than what is needed for direct connection of an RFID chip 24. For example, while an approximately 500 μm slit may be sufficient for separating two portions of the antenna 14 for direct connection of an RFID chip 24 (as in FIG. 1), a gap on the order of approximately 2 mm×2 mm may be required when using an RFID strap 26. Such a larger gap 28 can be seen in FIGS. 2 and 3, with FIG. 2 showing the underlying substrate 30. If the substrate 30 has different optical properties than the conductive material 12 (namely, if the substrate 30 is less opaque than the conductive material 12), then the RFID strap 26 may be provided with an associated strap substrate 32 (FIG. 3) configured to overlay all or portion of the gap 28. The strap substrate 32 may be formed of a material having optical properties that are more similar to those of the conductive material 12 than the substrate 30 (e.g., a strap substrate 32 formed of an opaque or colored paper or polyethylene terephthalate material), thereby preserving the controlled, substantially uniform optical properties of the RFID device 10b. Alternatively, if it is impracticable to provide a strap substrate 32, another option would be positioning the gap 28 at a location where transmission of light through the substrate 30 will have a minimal impact on the visual properties of the RFID device.

A comparison of FIGS. 2 and 3 shows additional processing that the periphery 16 may undergo. In particular, the periphery 16 of FIG. 3 has the same perimeter as the periphery 16 of FIG. 2; however, the periphery 16 of FIG. 3 has been separated into a plurality of portions or sections 16a, 16b, and 16c by one or more gaps 34 defined in the periphery 16. Separating the periphery 16 into multiple sections will electrically isolate the sections from each other, which may improve performance of the antenna 14. The gap(s) 34 defined in the periphery 16 may be formed according to the same approach employed in defining the gap 18 that separates the antenna 14 from the periphery 16 or may be formed according to a different approach. It may be advantageous for the gap(s) 34 defined between adjacent portions of the periphery 16 to be relatively narrow (similar to the gap(s) 18 between the antenna 14 and the periphery 16) in order to promote uniform optical properties, though it is also within the scope of the present disclosure for at least a portion of each gap 34 to have a greater width in order to allow for passage of a predetermined amount of light. Similar to the gap(s) 18 between the antenna 14 and the periphery 16, it may be advantageous for the gap(s) 34 to pass entirely through the conductive material 12 without extending into the substrate (which could weaken the substrate), though it is also within the scope of the present disclosure for at least a portion of a gap 34 to extend into the underlying substrate.

A comparison of FIGS. 2 and 3 to FIG. 1 shows another approach to reducing the visibility of the gap 18. In the embodiment of FIG. 1, the antenna 14 is defined by a gap 18 having a plurality of elongated, substantially linear segments or sections. In contrast, in the embodiment of FIGS. 2 and 3, the gap 18 separating the antenna 14 and the periphery 16 follows a continuously changing, non-linear path. A gap may be particularly visible at elongated, substantially linear segments, such that replacing such segments with less linear segments (e.g., sinusoidal or curving segments of the type shown in FIGS. 2 and 3) may render the gap less visually distinct. It should be understood that the non-linear path of the gap 18 of FIGS. 2 and 3 is merely exemplary and that a gap (or one or more segments thereof) may follow a differently configured non-linear path without departing from the scope of the present disclosure.

FIG. 4 shows another embodiment of an RFID device 10c with controlled optical properties according to an aspect of the present disclosure. In the embodiment of FIG. 4, a conductive material 12 is provided, with one or more gaps 18 being defined in the conductive material 12, as in the embodiments of FIGS. 1-3. Unlike the embodiments of FIGS. 1-3, the conductive material 12 is not separated into an antenna 14 and a periphery 16, but rather the entire conductive material 12 serves as the antenna 14. In the embodiment shown in FIG. 4, the gap(s) 18 define a substantially spiral-shaped antenna 14, but it should be understood that the antenna 14 may be differently configured, i.e., different spiral or other shape, without departing from the scope of the present disclosure. For example, if desired, the configuration could take the shape of a “logo” or other desired optical characteristic. As an embodiment, thin gaps isolating the sections of the conductor to form an antenna are in the desired shape or configuration or optical characteristic. If desired, light leakage through the thin gap can enhance the visual appeal of the label.

As in the embodiments of FIGS. 1-3, the gap(s) 18 may be formed according to any suitable approach and may be either relatively narrow (to minimize the amount of light transmitted therethrough and promote more uniform optical properties) or may be wider at one or more sections to allow a predetermined amount of light therethrough to provide a desired visual effect. FIG. 4 illustrates a gap 18 defined by a plurality of segments each following a non-linear path (as in FIGS. 2 and 3), but it should be understood that an individual segment of the gap 18 of FIG. 4 may be differently configured without departing from the scope of the present disclosure, including one or more segments that are substantially linear, as in FIG. 1.

FIG. 4 shows an RHD chip 24 electrically coupled to the antenna 14 at or adjacent to an outer perimeter of the conductive material 12. It should be understood that an RFID chip 24 may be positioned elsewhere on the antenna 14 without departing from the scope of the present disclosure and that it is also contemplated that an RFID strap (e.g., of the type shown in FIG. 3) may be employed instead of an RFID chip 24 that is directly connected to the antenna 14.

According to yet another approach to reducing the visibility of a substrate through a gap defined in a conductive material, the RFID device may further include a masking member or material having optical properties (e.g., opacity) that are more similar to that of the conductive material than the substrate. In one embodiment, the masking member may be provided as a distinct layer, which overlays all or a portion of the gap, being positioned on the same side of the substrate as the conductive material or on the opposite side of the substrate. This is comparable to FIG. 3, in which the strap substrate 32 overlays the gap 28, with the strap substrate 32 having optical properties that are more similar to those of the conductive material 12 than the substrate 30.

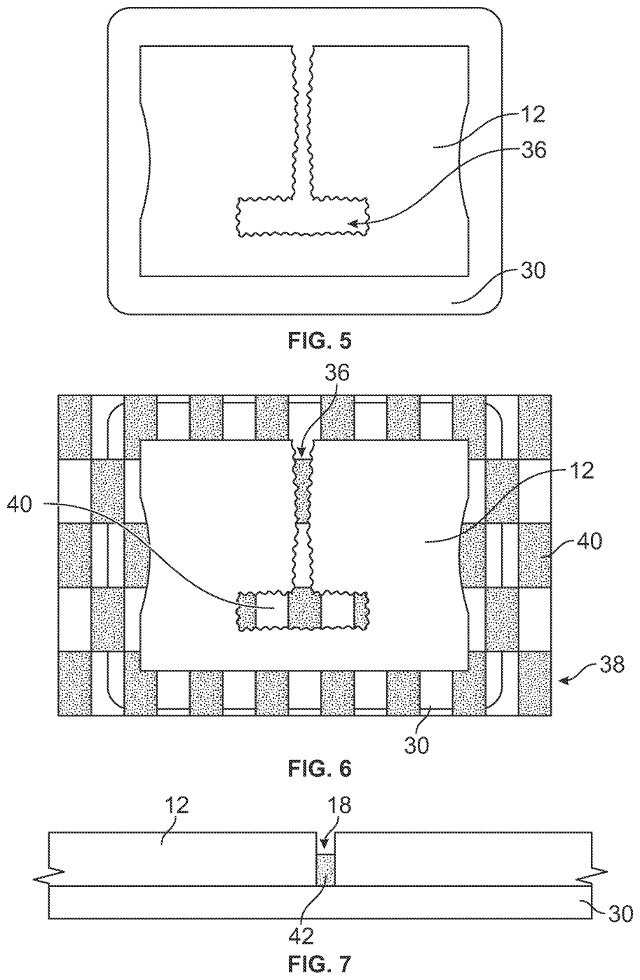

Rather than being entirely uniform, the masking member may have varying optical properties. This may include the masking member including a plurality of regions or sections having optical properties that are similar to those of the conductive material, with the regions or sections being arranged in pattern, which may be random or non-random. For example, FIG. 5 shows a conductive material 12 on a substrate 30, with a gap 36 defined in the conductive material 12 and with the substrate 30 being visible through the gap 36. The size of the gap 36 is exaggerated or enlarged for illustrative purposes. FIG. 6 shows the same conductive material 12 and substrate 30 of FIG. 5, but with a masking member 38 associated with the side of the substrate 30 opposite the conductive material 12. For illustrative purposes, the masking member 38 is shown as extending beyond the perimeter of the substrate 30, but it should be understood that the masking member 38 may be coextensive with the substrate 30 or may be positioned entirely inwardly of the perimeter of the substrate 30.

The masking member 38 of FIG. 6 is illustrated as being formed of a substantially transparent material (e.g., a thermoplastic urethane material), with opaque regions or sections 40 arranged in a checkerboard or pixelated pattern. The opaque regions or sections 40 have an opacity that is similar to that of the conductive material 12, such that the portions of the opaque regions or sections 40 aligned with the gap 36 will reduce the visibility of the substrate 30 through the gap 36. It should be understood that the illustrated configuration is merely exemplary and that the masking member 38 may be differently configured, such as by having a uniform opacity or an opacity gradient, which would serve to feather, fade, or blend the edges of the substrate 30 visible through the gap 36.

In yet another embodiment, rather than the masking member or material being provided as a separate layer, the masking member or material may be co-planar with and received by the gap 18. For example, paint or some other non-conductive masking member or material 42 may be at least partially positioned within the gap 18 to prevent light from passing through the gap 18 or at least reduce the amount of light that passes through the gap 18, as shown in FIG. 7. This may include the entire gap 18 being filled with the masking member or material 42 or only a portion of the gap 18 receiving the masking member or material 42. Typically, only a small amount of the masking member or material 42 is required to obscure the gap 18 (particularly if the gap 18 is narrow, as described above), such that the addition of the masking member or material 42 will not significantly diminish the flexibility of the resulting RFID device.

It will be understood that the aspects, embodiments and examples described herein are illustrative examples of some of the applications of the principles of the present subject matter. Numerous modifications may be made by those skilled in the art without departing from the spirit and scope of the claimed subject matter, including those combinations of features that are individually disclosed or claimed herein. For these reasons, the scope hereof is not limited to the above description but is as set forth in the following claims, and it is understood that claims may be directed to the features hereof, including as combinations of features that are individually disclosed or claimed herein.

1. A method for manufacturing an RFID device with controlled optical properties, comprising:
providing a conductive material on a substrate comprising one or more branding symbols;
processing the conductive material to separate an antenna from a periphery wherein the periphery is retained on the substrate, and
forming one or more gaps to allow for the passage of a predetermined amount of light.

2. The method of claim 1, wherein processing the conductive material comprises creating the one or more gaps along a perimeter of the one or more branding symbols.

3. The method of claim 1, wherein creating the one or more gaps along the perimeter of the one or more branding symbols enables enhancement of visibility of the one or more branding symbols.

4. The method of claim 1, wherein processing the conductive material comprises creating the one or more gaps between the antenna and the periphery having a width in the range of approximately 25 μm-200 μm.

5. The method of claim 1, wherein processing the conductive material comprises processing the conductive material using a process selected from the group consisting of cutting, laser-cutting, and etching.

6. The method of claim 1, wherein the antenna is completely surrounded by the periphery.

7. The method of claim 1, wherein processing the conductive material comprises separating the antenna from the periphery renders the antenna to be almost invisible.

8. The method of claim 1, wherein the antenna comprises first and second portions, and wherein an RFID chip is electrically coupled to the antenna.

9. The method of claim 8, wherein the RFID chip is associated with a strap substrate at least partially formed of an opaque material and configured to extend between the first and second portions of the antenna.

10. The method of claim 1, further comprising defining at least one gap in the periphery to separate a first portion of the periphery from a second portion of the periphery, and wherein the at least one gap is formed to allow for passage of a predetermined amount of light therethrough.

11. The method of claim 1, further comprising applying a masking material or member to the RFID device to reduce the visibility of the substrate through the one or more gaps defined between the antenna and the periphery.

12. The method of claim 11, wherein the masking material or member is co-planar with the conductive material.

13. The method of claim 11, wherein the masking material or member and the conductive material are positioned in different planes.

14. The method of claim 1, wherein
processing the conductive material to separate the antenna from the periphery comprises creating the one or more gaps between the antenna and the periphery, and
the one or more gaps is defined by at least one segment following a non-linear path.

15. A method for manufacturing an RFID device with controlled optical properties, comprising:
printing a conductive material onto a substrate to define an antenna and a peripheral portion, wherein the substrate carries one or more branding symbols; and
processing the conductive material to separate the antenna from the periphery, wherein the periphery is retained on the substrate, and
forming one or more gaps to allow for passage of a predetermined amount of light therethrough.

16. The method of claim 15, wherein processing the conductive material comprises creating the one or more gaps along a perimeter of the one or more branding symbols formed on the substrate.

17. The method of claim 15, wherein creating the one or more gaps along the perimeter of the one or more branding symbols enables enhancement of visibility of the one or more branding symbols.

18. The method of claim 15, wherein printing the conductive material onto the substrate comprises creating one or more gaps between the antenna and the periphery having a width in the range of approximately 25 μm-200 μm.

19. The method of claim 15, further comprising applying a masking material or member to the RFID device to reduce the visibility of the substrate through the one or more gaps defined between the antenna and the periphery.

20. The method of claim 19, wherein the masking material or member is co-planar with the conductive material.

21. The method of claim 19, wherein the masking material or member and the conductive material are positioned in different planes.

22. The method of claim 15, wherein
printing the conductive material onto the substrate includes creating one or more gaps between the antenna and the periphery, and
the one or more gaps is defined by at least one segment following a non-linear path.

23. An RFID device with controlled optical properties, comprising:
a substrate carrying one or more branding symbols;
a conductive material associated with the substrate and comprising an antenna separated from a periphery by one or more gaps formed therein to allow for passage of a predetermined amount of light therethrough; and
an RFID chip electrically coupled to the antenna and away from the periphery.

24. The RFID device of claim 23, wherein the one or more gaps are formed along a perimeter of the one or more branding symbols formed on the substrate.

25. The RFID device of claim 23, wherein passage of the predetermined amount of light through the one or more gaps enhances visibility of the one or more branding symbols.

26. The RFID device of claim 23, wherein the one or more gaps formed between the antenna and the periphery have a width in the range of approximately 25 μm-200 μm.

27. The RFID device of claim 23, wherein the antenna is completely surrounded by the periphery.

28. The RFID device of claim 23, wherein the antenna includes first and second portions, and wherein the antenna is directly electrically coupled to an RFID chip.

29. The RFID device of claim 23, wherein the RFID chip is associated with a strap substrate at least partially formed of an opaque material and extending between the first and second portions of the antenna.

30. The RFID device of claim 23, further comprising at least one gap in the periphery separating a first portion of the periphery from a second portion of the periphery.

31. The RFID device of claim 23, further comprising a masking material or member configured to reduce the visibility of the substrate through a gap defined between the antenna and the periphery.

32. The RFID device of claim 31, wherein the masking material or member is co-planar with the conductive material.

33. The RFID device of claim 31, wherein the masking material or member and the conductive material are positioned in different planes.

34. The RFID device of claim 23, wherein
the one more gaps between the antenna and the periphery is defined by at least one segment following a non-linear path.
